(19) United States
(12) Patent Application Publication
(10) Pub. No.: US 2026/0221858 A1
(43) Pub. Date: Jul. 30, 2026

(54) SWITCHING CONVERTER WITH IMPROVED TRANSIENT RESPONSE

(71) Applicant: Chengdu Monolithic Power Systems Co., Ltd., Chengdu (CN)

(72) Inventor: Zhijiang Yang, Chengdu (CN)

(21) Appl. No.: 19/438,224

(22) Filed: Dec. 31, 2025

(30) Foreign Application Priority Data
Jan. 24, 2025 (CN) 202510117832.X

(51) Int. Cl. H02M 1/00; H02M 1/08; H02M 3/158

(52) U.S. Cl. CPC H02M 1/0022; H02M 1/0009; H02M 1/08; H02M 3/158

(57) ABSTRACT

A control circuit for a switching converter. The control circuit includes an input voltage detection circuit, a compensation current generator and a comparison circuit. The input voltage detection circuit generates a first voltage signal indicative of the input voltage and generates a second voltage signal by low-pass filtering the input voltage. The compensation current generator generates a compensation current signal based on the first voltage signal and the second voltage signal. The comparison circuit generates a turning off control signal to control the turning off of a power switch of the switching converter based on the compensation current signal, a current sensing signal indicative of a current flowing through the power switch and a reference signal.

### CROSS-REFERENCE TO RELATED APPLICATIONS

This application claims the benefit of CN application 202510117832.X, filed on January 24, 2025, and incorporated herein by reference.

### TECHNICAL FIELD OF THE INVENTION

The present invention generally relates to electronic circuits, and more particularly but not exclusively, to switching converters.

### BACKGROUND OF THE INVENTION

In recent years, many electronic devices have adopted OLED (Organic Light-Emitting Diode). An OLED driver (e.g., a switching power supply) generates an output voltage to drive panels based on an input voltage. When an electronic device is plugged into or unplugged from an adapter, the input voltage will change rapidly. In order to avoid panel flicker, the output voltage is required to keep stable during input voltage transients. Therefore, it is required to propose a switching power supply with excellent transient response to a change in the input voltage, capable of maintaining stable output voltage during input voltage transients.

### SUMMARY OF THE INVENTION

An embodiment of the present invention discloses a control circuit for a switching converter converting an input voltage to an output voltage. The control circuit includes an input voltage detection circuit, a compensation current generator and a comparison circuit. The input voltage detection circuit is configured to generate a first voltage signal indicative of the input voltage and configured to generate a second voltage signal by low-pass filtering the input voltage. The compensation current generator is configured to generate a compensation current signal based on the first voltage signal and the second voltage signal. The comparison circuit is configured to generate a turning off control signal to control the turning off of a power switch of the switching converter based on the compensation current signal, a current sensing signal indicative of a current flowing through the power switch and a reference signal.

An embodiment of the present invention discloses a switching converter. The switching converter includes a switching circuit, an input voltage detection circuit, a compensation current generator and a comparison circuit. The switching circuit has a power switch and is configured to convert an input voltage to an output voltage. The input voltage detection circuit is configured to generate a first voltage signal indicative of the input voltage and configured to generate a second voltage signal by low-pass filtering the input voltage. The compensation current generator is configured to generate a compensation current signal based on the first voltage signal and the second voltage signal. The comparison circuit is configured to generate a turning off control signal to control the turning off of the power switch based on the compensation current signal, a current sensing signal indicative of a current flowing through the power switch and a reference signal.

An embodiment of the present invention discloses a control method for a switching converter converting an input voltage to an output voltage. The control method includes the following steps. 1) Monitoring the input voltage. 2) Generating a compensation current signal varying with a change in the input voltage. And 5) generating a turning off control signal to control the turning off of a power switch of the switching converter based on the compensation current signal, a current sensing signal indicative of a current flowing through the power switch and a reference signal.

### BRIEF DESCRIPTION OF DRAWINGS

The present invention can be further understood with reference to the following detailed description and the appended drawings, wherein like elements are provided with like reference numerals.

FIG. 1 illustrates a circuit block diagram of a switching converter 100 in accordance with an embodiment of the present invention.

FIG. 2 illustrates a working waveform of the switching converter 100 in accordance with an embodiment of the present invention.

FIG. 3(a) and FIG. 3(b) respectively illustrate simulation waveforms of a prior art switching converter and the switching converter 100 in accordance with an embodiment of the present invention.

FIG. 4 illustrates a circuit block diagram of a switching converter 100A in accordance with another embodiment of the present invention.

FIG. 5 illustrates a circuit block diagram of a switching converter 100B in accordance with yet another embodiment of the present invention.

FIG. 6 illustrates a circuit schematic of a control circuit 11C for the switching converter 100 in accordance with an embodiment of the present invention.

FIG. 7 illustrates a circuit schematic of a control circuit 11D for the switching converter 100 in accordance with another embodiment of the present invention.

FIG. 8 illustrates a working flowchart of a control method 800 for a switching converter in accordance with an embodiment of the present invention.

### DETAILED DESCRIPTION OF THE INVENTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well-known methods, procedures, components, and circuits have not been described in detail so as not to unnecessarily obscure aspects of the present invention.

Reference to "one embodiment", "an embodiment", "an example" or "examples" means: certain features, structures, or characteristics are contained in at least one embodiment of the present invention. These "one embodiment", "an embodiment", "an example" and "examples" are not necessarily directed to the same embodiment or example. Furthermore, the features, structures, or characteristics may be combined in one or more embodiments or examples. In addition, it should be noted that the drawings are provided for illustration and are not necessarily to scale. And when an element is described as "connected" or "coupled" to another element, it can be directly connected or coupled to the other element, or there could exist one or more intermediate elements. In contrast, when an element is referred to as "directly connected" or “directly coupled” to another element, there is no intermediate element.

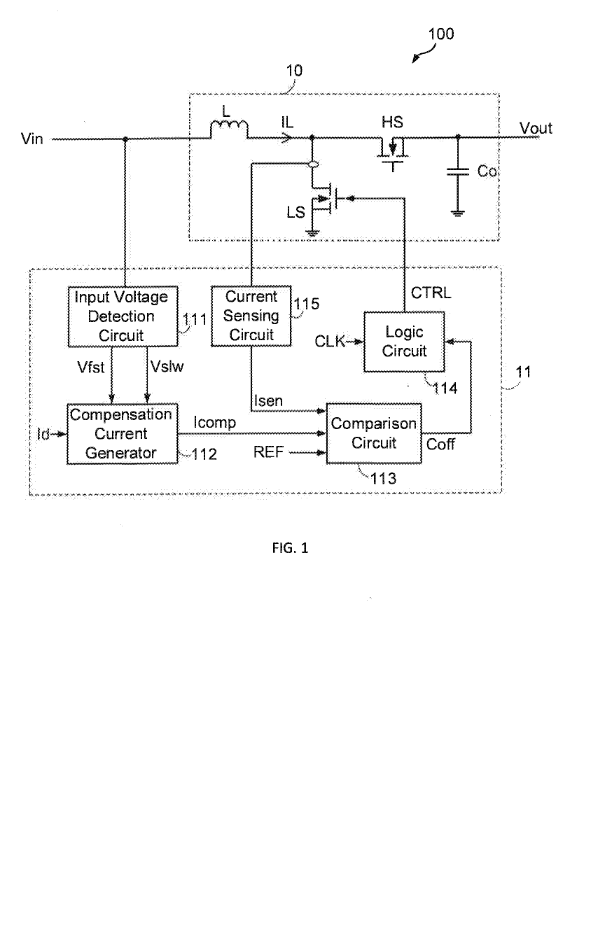

FIG. 1 illustrates a circuit block diagram of a switching converter 100 in accordance with an embodiment of the present invention. As shown in FIG. 1, the switching converter 100 includes a switching circuit 10 and a control circuit 11. The switching circuit 10 employs a boost converter topology, including an inductor L, a high-side power switch HS, a low-side power switch LS and an output capacitor Co. An inductor current IL flows through the inductor L. The switching circuit 10 converts an input voltage Vin to an output voltage Vout to power a load (not shown) by turning on and turning off the power switches HS and LS. Those skilled in the art can understand that the switching circuit 10 may be configured as any suitable DC/DC or AC/DC converter topology, such as synchronous or asynchronous buck, boost, buck-boost, forward, or flyback converters and so on. The power switches HS and LS may be any controllable semiconductor device, such as BJT, JFET, MOSFET, IGBT and so on. In other embodiments, the power switch HS may be replaced by a diode.

The control circuit 11 includes an input voltage detection circuit 111, a compensation current generator 112, a comparison circuit 113 and a logic circuit 114. The control circuit 11 generates a switch control signal CTRL to control the power switch LS. Those skilled in the art can understand that the power switch HS may be controlled by an inverted signal of the switch control signal CTRL. This is not shown in FIG. 1 for simplicity.

The input voltage detection circuit 111 is configured to receive the input voltage Vin and to generate at least one signal indicative of the input voltage Vin. In one embodiment, the at least one signal may indicate both a direction of a change in the input voltage Vin (e.g., increases or decreases) and a magnitude of the change in the input voltage Vin.

In the example shown in FIG. 1, the input voltage detection circuit 111 generates a first voltage signal Vfst indicative of the input voltage Vin and low-pass filters the input voltage Vin to generate a second voltage signal Vslw. The first voltage signal Vfst and the second voltage signal Vslw indicate the change in the input voltage Vin together. Those skilled in the art can understand that the case where the input voltage detection circuit 111 low-pass filters the input voltage Vin to generate the second voltage signal Vslw also includes the case where the input voltage detection circuit 111 low-pass filters a signal indicative of the input voltage Vin ( for example, a divided voltage of the input voltage Vin) to generate the second voltage signal Vslw.

The compensation current generator 112 is coupled to the input voltage detection circuit 111 and generates a compensation current signal Icomp varying with the change in the input voltage Vin. In one embodiment, when the input voltage Vin increases, the compensation current signal Icomp increases; when the input voltage Vin decreases, the compensation current signal Icomp decreases. In one embodiment, the compensation current signal Icomp is a current signal. In other embodiments, the compensation current signal can also be a voltage signal.

In the example shown in FIG. 1, the compensation current generator 112 receives the first voltage signal Vfst and the second voltage signal Vslw and generates the compensation current signal Icomp based on the first voltage signal Vfst and the second voltage signal Vslw.

In the example shown in FIG. 1, the compensation current generator 112 further receives a load current signal Id indicative of the load condition and generates the compensation current signal Icomp based on the first voltage signal Vfst, the second voltage signal Vslw and the load current signal Id. In one embodiment, the compensation current signal Icomp is related to a difference between the first voltage signal Vfst and the second voltage signal Vslw. The compensation current signal Icomp increases as the difference between the first voltage signal Vfst and the second voltage signal Vslw increases, and the compensation current signal Icomp decreases as the difference between the first voltage signal Vfst and the second voltage signal Vslw decreases. In one embodiment, a maximum change in the compensation current signal Icomp is related to the load current signal Id. In a further embodiment, the maximum change in the compensation current signal Icomp is proportional to the load current signal Id. Those skilled in the art can understand that the load current signal Id may be generated by detecting the inductor current IL or by detecting a signal at the output of the switching circuit 10.

The comparison circuit 113 generates a turning off control signal Coff to control the turning off of the power switch LS based on the compensation current signal Icomp, a current sensing signal Isen indicative of a current flowing through the power switch LS and a reference signal REF. In one embodiment, when a superimposed signal of the current sensing signal Isen and the compensation current signal Icomp reaches the reference signal REF, or when a scaled superimposed signal of the current sensing signal Isen and the compensation current signal Icomp reaches the reference signal REF, the turning off control signal Coff becomes valid (e.g., high level), and the power switch LS is turned off. In one embodiment, the reference signal REF is related to an output signal (e.g., the output voltage Vout) of the switching converter 100. In other embodiments, in order to prevent subharmonic oscillations, the comparison circuit 113 further receives a ramp current signal and generates the turning off control signal Coff based on the ramp current signal, the compensation current signal Icomp, the current sensing signal Isen and the reference signal REF.

In the example shown in FIG. 1, the control circuit 11 further includes a current sensing circuit 115 coupled to the power switch LS for generating the current sensing signal Isen. The current sensing circuit 115 may be a resistor sensing circuit, a transformer sensing circuit, a current amplifier sensing circuit and so on. In one embodiment, when the power switch LS is turned on and the power switch HS is turned off, the inductor current IL increases, and the current flowing through the power switch LS equals the inductor current IL. Thus, the current sensing signal Isen represents the inductor current IL during the period when the inductor current IL increases.

The logic circuit 114 generates the switch control signal CTRL to control the power switch LS based on a clock signal CLK and the turning off control signal Coff. In one embodiment, the power switch LS is turned on when the clock signal CLK arrives.

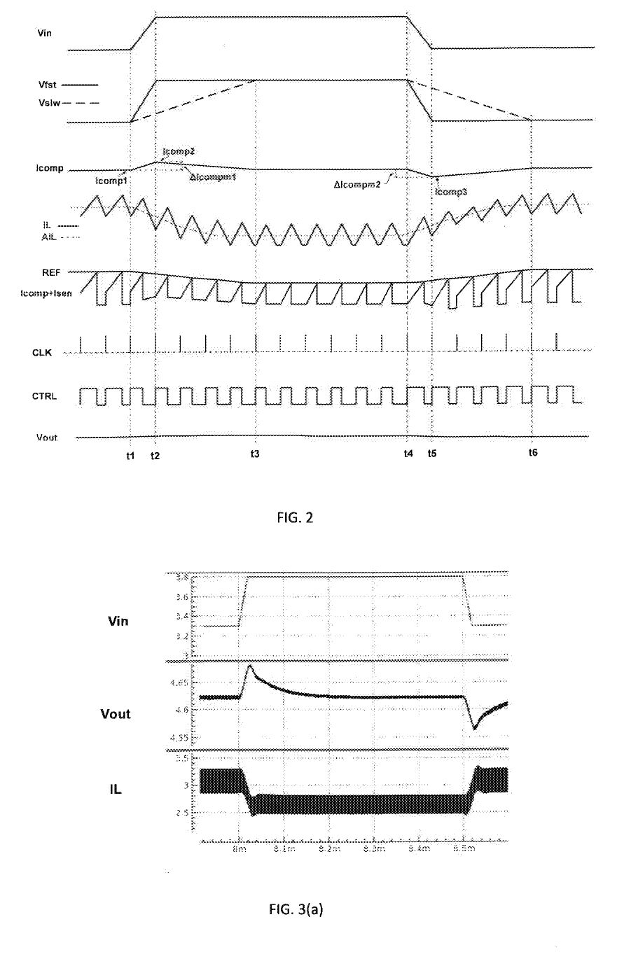

FIG. 2 illustrates a working waveform of the switching converter 100 in accordance with an embodiment of the present invention. As shown in FIG. 2, when the clock signal CLK arrives, the switch control signal CTRL transitions from a low level to a high level, the power switch LS is turned on. The inductor current IL gradually increases, and the current sensing signal Isen also gradually increases. When a sum of the current sensing signal Isen and the compensation current signal Icomp increases to the reference signal REF, the switch control signal CTRL transitions from the high level to the low level, the power switch LS is turned off, and the inductor current IL gradually decreases.

Before time t1, the input voltage Vin remains stable, the compensation current signal Icomp stays at a steady-state value Icomp1, an average inductor current AIL (i.e., the average value of the inductor current IL) remains unchanged, and the output voltage Vout remains stable.

During time period t1~t2, the input voltage Vin increases. The difference between the first voltage signal Vfst and the second voltage signal Vslw increases, the compensation current signal Icomp increases accordingly. The average inductor current AIL decreases rapidly. This prevents excessive energy storage in the inductor L. As a result, there is little or no additional energy transferred to the output voltage Vout and the output voltage Vout exhibits no significant overshoot.

At time t2, the input voltage Vin stops to increase, and the compensation current signal Icomp reaches its maximum value Icomp2. At this time, the change in input voltage Vin achieves its maximum magnitude, and the change in compensation current signal Icomp also reaches its maximum value ΔIcompm1. Here, ΔIcompm1=Icomp2-Icomp1. In one embodiment, the maximum change ΔIcompm1 in the compensation current signal Icomp is proportional to the load current signal Id.

During time period t2~t3, the input voltage Vin remains stable. The difference between the first voltage signal Vfst and the second voltage signal Vslw decreases. The compensation current signal Icomp gradually decreases from its maximum value Icomp2 until it recovers to the steady-state value Icomp1. The average inductor current AIL gradually decreases. The compensation current signal Icomp gradually decreasing allows the control loop of the switching converter 100 sufficient time to adjust, preventing rapid change in the average inductor current AIL. This enables the switching converter 100 to transition to the next steady state (e.g., time period t3~t4) smoothly.

During time period t3~t4, the switching converter 100 operates in steady state. The difference between the first voltage signal Vfst and the second voltage signal Vslw is zero substantially. The compensation current signal Icomp remains at the steady- state value Icomp1, the average inductor current AIL also remains unchanged, and the output voltage Vout remains stable.

During time period t4~t5, the input voltage Vin decreases. The difference between the first voltage signal Vfst and the second voltage signal Vslw decreases, the compensation current signal Icomp decreases accordingly. The average inductor current AIL rapidly increases. This enables sufficient energy to be stored into the inductor L quickly and transferred to the output voltage Vout. Thus, there is no significant undershoot in the output voltage Vout.

At time t5, the input voltage Vin stops to decrease, and the compensation current signal Icomp decreases to its minimum value Icomp3. At this time, the change in input voltage Vin reaches its maximum, and the change in compensation current signal Icomp also reaches its maximum value ΔIcompm2. Here, ΔIcompm2=Icomp1-Icomp3. In one embodiment, the maximum change ΔIcompm2 in the compensation current signal Icomp is proportional to the load current signal Id. In one embodiment, the load current signal Id remains constant during time period t1~t6, and the change in the input voltage Vin during time period t1~t2 is identical to its change during time period t4~t5, then the maximum change ΔIcompm1 in the compensation current signal Icomp during time period t1~t2 is also identical to its maximum change ΔIcompm2 during time period t4~t5.

During time period t5~t6, the difference between the first voltage signal Vfst and the second voltage signal Vslw increases. The compensation current signal Icomp gradually increases from its minimum value Icomp3 until it recovers to its steady-state value Icomp1. The average inductor current AIL continues to increase. The compensation current signal Icomp gradually increasing allows the control loop of the switching converter 100 sufficient time to adjust, preventing rapid change in the average inductor current AIL. This enables the switching converter 100 to transition to the next steady state (e.g., after time t6) smoothly.

After time t6, the switching converter 100 operates in steady state. The difference between the first voltage signal Vfst and the second voltage signal Vslw is zero substantially. The compensation current signal Icomp no longer changes and remains at the steady-state value Icomp1. The average inductor current AIL remains unchanged, and the output voltage Vout remains stable.

Those skilled in the art can understand that the above embodiments are used for illustrative purposes, not for limiting the scope of the present invention. Other circuits capable of achieving the same or similar functions also fall within the spirit and scope of the present invention, provided that when the input voltage Vin suddenly increases, the variable compensation current signal Icomp can rapidly decrease the average inductor current AIL through the control loop; when the input voltage Vin suddenly decreases, the variable compensation current signal Icomp can rapidly increase the average inductor current AIL through the control loop, thereby maintaining the stability of the output voltage Vout. For example, in one embodiment, the compensation current signal Icomp decreases as the input voltage Vin increases and increases as the input voltage Vin decreases. In this situation, the compensation current signal Icomp is superimposed not on the current sensing signal Isen but on the reference signal REF. When the current sensing signal Isen increases to the superimposed signal of reference signal REF and the compensation current signal Icomp, the power switch LS is turned off.

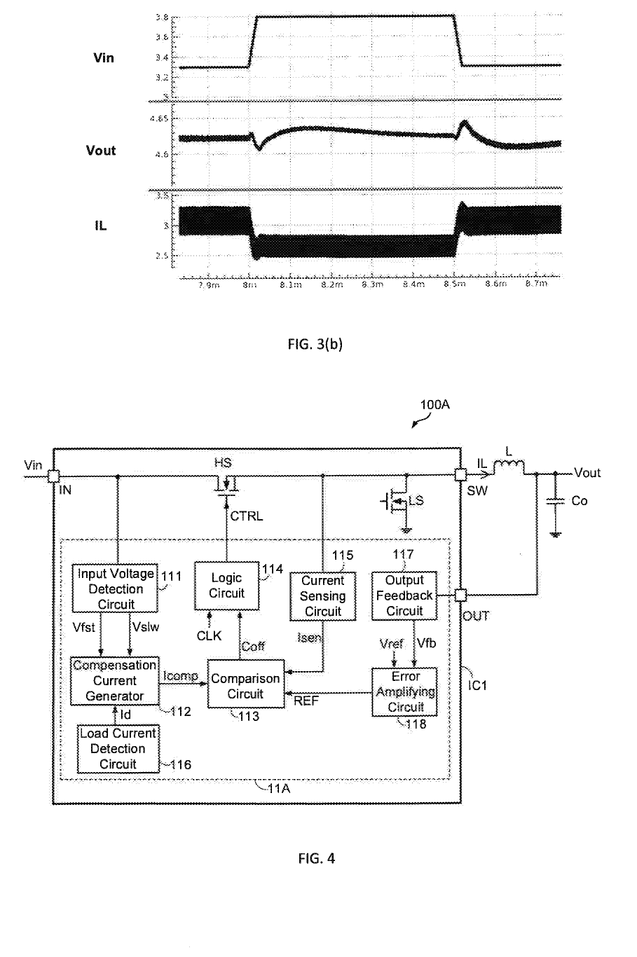

FIG. 3(a) and FIG. 3(b) respectively illustrate simulation waveforms of a prior art switching converter and the switching converter 100 in accordance with an embodiment of the present invention.

As shown in FIG. 3(a) and FIG. 3(b), compared to the prior art switching converter, when the input voltage Vin changes suddenly, the inductor current IL of the switching converter 100 can change more rapidly to adapt to the change in the input voltage Vin, resulting in a significant reduction in both the overshoot and undershoot in the output voltage Vout.

According to the embodiments of the present invention, when the input voltage Vin increases, the average inductor current AIL can decrease rapidly. When the input voltage Vin decreases, the average inductor current AIL can increase rapidly. The energy stored in the inductor L can rapidly change with the change in the input voltage Vin, preventing excessive or insufficient energy transferred to the output voltage Vout. This can improve the transient response of the switching converter 100 and reduces the overshoot or undershoot in the output voltage Vout significantly, enabling the output voltage Vout to remain stable when the input voltage Vin changes.

FIG. 4 illustrates a circuit block diagram of a switching converter 100A in accordance with another embodiment of the present invention. The switching converter 100A employs a buck converter topology, including a power switch HS, a power switch LS, an inductor L and an output capacitor Co, connected as shown in FIG. 4. The control circuit 11A generates a switch control signal CTRL to control the power switch HS. The power switch LS may be controlled by the inverted signal of the switch control signal CTRL. This is not shown in FIG. 4 for simplicity.

In the example shown in FIG. 4, the control circuit 11A, the power switch HS and power switch LS are integrated into a single integrated circuit IC1. The integrated circuit IC1 has a plurality of pins, including an input pin IN coupled to receive the input voltage Vin, a switch pin SW coupled to a common connection node of the power switches HS and LS, and an output pin OUT coupled to receive the output voltage Vout.

The control circuit 11A includes an input voltage detection circuit 111, a compensation current generator 112, a comparison circuit 113, a logic circuit 114, a current sensing circuit 115, a load current detection circuit 116, an output feedback circuit 117 and an error amplifying circuit 118.

The input voltage detection circuit 111 is coupled to the input pin IN to receive the input voltage Vin, and generates the first voltage signal Vfst and the second voltage signal Vslw based on the input voltage Vin.

The load current detection circuit 116 generates the load current signal Id indicative of the load condition.

The compensation current generator 112 is coupled to the input voltage detection circuit 111 and the load current detection circuit 116, and generates the compensation current signal Icomp based on the first voltage signal Vfst, the second voltage signal Vslw and the load current signal Id.

The current sensing circuit 115 is coupled to the switch pin SW and generates a current sensing signal Isen indicative of the current flowing through the power switch HS. In one embodiment, when the power switch HS is turned on and the power switch LS is turned off, the inductor current IL increases, and the current flowing through the power switch HS equals the inductor current IL. Thus, the current sensing signal Isen represents the inductor current IL during the period when the inductor current IL increases.

The output feedback circuit 117 is coupled to the output pin OUT to receive the output voltage Vout and generates an output voltage feedback signal Vfb indicative of the output voltage Vout.

The error amplifying circuit 118 is coupled to the output feedback circuit 117 to receive the output voltage feedback signal Vfb and generates the reference signal REF based on the output voltage feedback signal Vfb and an output voltage reference signal Vref.

The comparison circuit 113 generates the turning off control signal Coff to control the turning off of the power switch HS based on the compensation current signal Icomp, the current sensing signal Isen and the reference signal REF.

The logic circuit 114 generates the switch control signal CTRL to control the power switch HS based on the clock signal CLK and the turning off control signal Coff.

The working principle of the control circuit 11A is similar to that of the control circuit 11 shown in FIG. 1 and thus is not repeated here for simplicity.

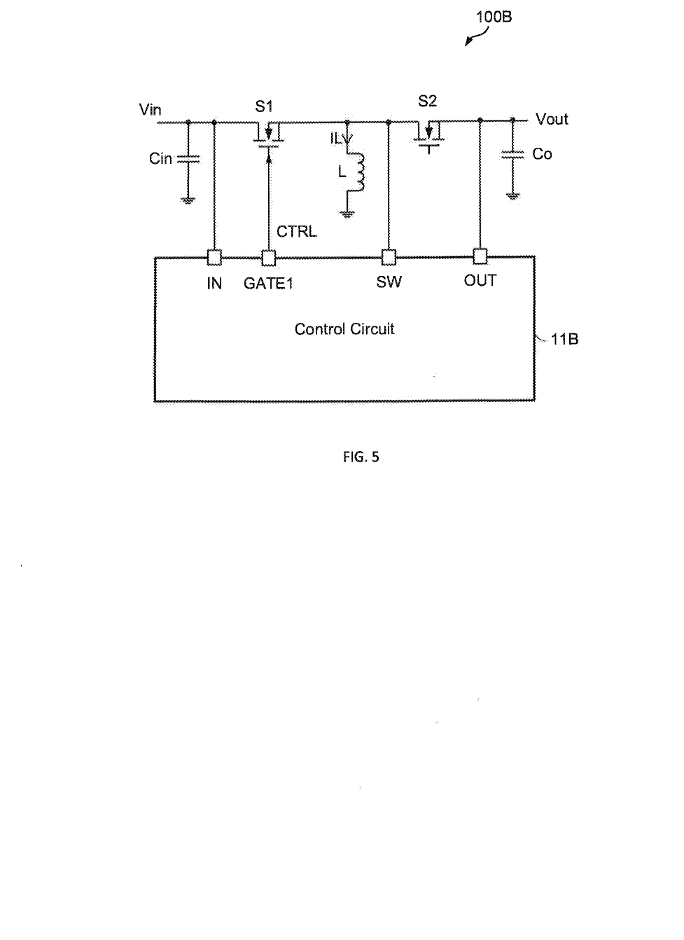

FIG. 5 illustrates a circuit block diagram of a switching converter 100B in accordance with yet another embodiment of the present invention. The switching converter 100B employs a buck-boost converter topology, including an input capacitor Cin, a power switch S1, an inductor L, a power switch S2 and an output capacitor Co, connected as shown in FIG. 5.

In the example shown in FIG. 5, the control circuit 11B has a plurality of pins, including an input pin IN coupled to receive the input voltage Vin, a driving pin GATE1 for providing a switch control signal CTRL to control the power switch S1, a switch pin SW coupled to the common connection node of the power switches S1 and S2, and an output pin OUT coupled to receive the output voltage Vout. The control circuit 11B generates the switch control signal CTRL to control the power switch S1. The power switch S2 may be controlled by the inverted signal of the switch control signal CTRL. This is not shown in FIG. 5 for simplicity.

The working principle of the control circuit 11B is similar to that of the control circuit 11 shown in FIG. 1 and the control circuit 11A shown in FIG. 4, and is not described in detail here for simplicity.

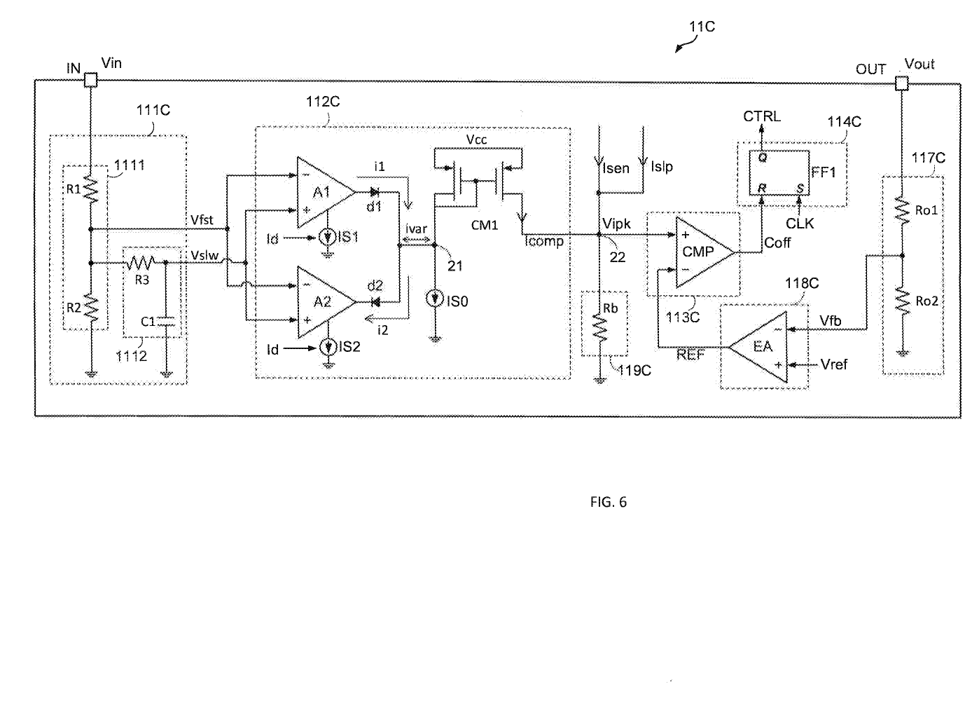

FIG. 6 illustrates a circuit schematic of a control circuit 11C for the switching converter 100 in accordance with an embodiment of the present invention. The control circuit 11C includes an input pin IN, an output pin OUT, an input voltage detection circuit 111C, a compensation current generator 112C, a comparison circuit 113C, a logic circuit 114C, an output feedback circuit 117C, an error amplifying circuit 118C, and a current voltage conversion circuit 119C.

The input voltage detection circuit 111C is coupled to the input pin IN to receive the input voltage Vin and generates the first voltage signal Vfst and the second voltage signal Vslw. In the example shown in FIG. 6, the input voltage detection circuit 111C includes a voltage dividing circuit 1111 and a low-pass filter 1112. The voltage dividing circuit 1111 includes resistors R1 and R2 and generates the first voltage signal Vfst by dividing the input voltage Vin. The low-pass filter 1112 includes a resistor R3 and a capacitor C1 and generates the second voltage signal Vslw by low-pass filtering the input voltage Vin or the divided voltage of the input voltage Vin (for example, the first voltage signal Vfst). In other embodiments, the input voltage detection circuit 111C may have an active filter including an operational amplifier, a resistor and a capacitor to filter the input voltage Vin or the divided voltage of the input voltage Vin.

The compensation current generator 112C receives the first voltage signal Vfst and the second voltage signal Vslw. When the first voltage signal Vfst is lower than the second voltage signal Vslw, a first current signal i1 is provided. When the first voltage signal Vfst is higher than the second voltage signal Vslw, a second current signal i2 is provided. The compensation current generator 112C generates the compensation current signal Icomp based on the first current signal i1 and the second current signal i2. In one embodiment, the first current signal i1 has a first direction, and the second current signal i2 has a second direction, where the first direction is opposite to the second direction (For example, the first current signal i1 flows into a node 21, the second current signal i2 flows out from the node 21).

In the example shown in FIG. 6, the compensation current generator 112C includes a first transconductance amplifier A1, a second transconductance amplifier A2, diodes d1 and d2, current sources IS0~IS2 and a first current mirror CM1.

The first transconductance amplifier A1 has a first input terminal, a second input terminal, a bias terminal and an output terminal. The first input terminal receives the first voltage signal Vfst, the second input terminal receives the second voltage signal Vslw, and the bias terminal is coupled to the current source IS1. In one embodiment, the current source IS1 provides a fixed current. In another embodiment, the current source IS1 is a controlled current source providing a current related to the load current signal Id.

The second transconductance amplifier A2 has a first input terminal, a second input terminal, a bias terminal and an output terminal. The first input terminal receives the first voltage signal Vfst, the second input terminal receives the second voltage signal Vslw, and the bias terminal is coupled to the current source IS2. In one embodiment, the current source IS2 provides a fixed current. In another embodiment, the current source IS2 is a controlled current source providing a current related to the load current signal Id.

The output terminal of the first transconductance amplifier A1 and the output terminal of the second transconductance amplifier A2 are coupled together to provide a current ivar. When the first voltage signal Vfst is lower than the second voltage signal Vslw, the current ivar is equal to the first current signal i1 and flows from the first transconductance amplifier A1 to the node 21; when the first voltage signal Vfst is higher than the second voltage signal Vslw, the current ivar is equal to the second current signal i2 and flows from the node 21 into the second transconductance amplifier A2. When the switch converter 100 is in steady state, the first voltage signal Vfst equals the second voltage signal Vslw, the current ivar is zero (or substantially zero). Those skilled in the art can understand that in the example shown in FIG. 6, diodes d1 and d2 are used to aid in understanding the direction of the first current signal i1 and the direction of the second current signal i2. Diodes d1 and d2 may be omitted in practical applications.

The current source IS0 is coupled between the node 21 and a reference ground. The first current mirror CM1 has a power supply terminal, a first terminal and a second terminal, where the power supply terminal is coupled to receive a supply voltage Vcc, and the first terminal is coupled to the node 21. The first current mirror CM1 provides the compensation current signal Icomp at the second terminal based on the current ivar and the current provided by the current source IS0.

The current voltage conversion circuit 119C generates a peak voltage signal Vipk at a node 22 based on the compensation current signal Icomp, the current sensing signal Isen and a ramp current signal Islp. In the example shown in FIG. 6, the current voltage conversion circuit 119C includes a resistor Rb. In another embodiment, the current voltage conversion circuit 119C includes a transimpedance amplifier.

The output feedback circuit 117C is coupled to the output pin OUT to receive the output voltage Vout and generates an output voltage feedback signal Vfb indicative of the output voltage Vout. In the example shown in FIG. 6, the output feedback circuit 117C includes resistors Ro1 and Ro2.

The error amplifying circuit 118C has a first input terminal, a second input terminal and an output terminal, where the first input terminal receives the output voltage feedback signal Vfb, and the second input terminal receives the output voltage reference signal Vref. Based on the difference between the output voltage reference signal Vref and the output voltage feedback signal Vfb, the error amplifying circuit 118C generates the reference signal REF at the output terminal. In one embodiment, the error amplifying circuit 118C includes an error amplifier EA.

The comparison circuit 113C has a first input terminal, a second input terminal and an output terminal, where the first input terminal receives the peak voltage signal Vipk, and the second input terminal receives the reference signal REF. The comparison circuit 113C generates a turning off control signal Coff by comparing the peak voltage signal Vipk with the reference signal REF. In one embodiment, the comparison circuit 113C includes a comparator CMP.

The logic circuit 114C includes a RS flip-flop FF1. The RS flip-flop FF1 has a set terminal S, a reset terminal R and an output terminal Q, where the set terminal S receives the clock signal CLK, the reset terminal R receives the turning off control signal Coff and the output terminal Q provides the switch control signal CTRL.

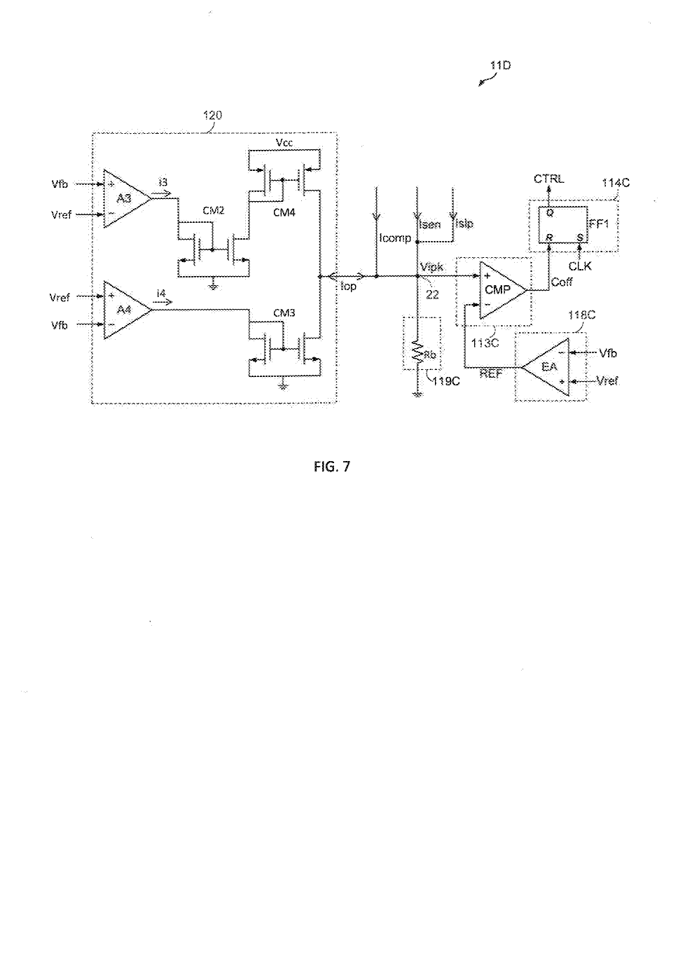

FIG. 7 illustrates a circuit schematic of a control circuit 11D for the switching converter 100 in accordance with another embodiment of the present invention. Different from the control circuit 11C shown in FIG. 6, the control circuit 11D further includes an output compensation circuit 120. As shown in FIG. 7, the output compensation circuit 120 generates an output compensation current signal Iop based on the output voltage reference signal Vref and the output voltage feedback signal Vfb. The peak voltage signal Vipk is generated at the node 22 based on the output compensation current signal Iop, the compensation current signal Icomp, the current sensing signal Isen and the ramp current signal Islp.

In one embodiment, during the time period when the output voltage Vout falls below an expected value (i.e, the output voltage feedback signal Vfb is lower than the output voltage reference signal Vref), the output compensation current signal Iop flows from the node 22 into the output compensation circuit 120 to discharge the peak voltage signal Vipk. When the power switch LS (see FIG. 1) is turned on and the power switch HS (see FIG. 1) is turned off, the peak voltage signal Vipk increases as the increase in the inductor current IL. Due to the output compensation current signal Iop being used to discharge the peak voltage signal Vipk, the peak voltage signal Vipk needs more time to increase to the reference voltage REF and the duty cycle of the switch control signal CTRL increases accordingly. As a result, the output voltage Vout recovers to the expected value rapidly. In another embodiment, during the time period when the output voltage Vout exceeds the expected value (i.e., the output voltage feedback signal Vfb is higher than the output voltage reference signal Vref), the output compensation current signal Iop flows out from the output compensation circuit 120 to the node 22 to charge the peak voltage signal Vipk. When the power switch LS (see FIG. 1) is turned on and the power switch HS (see FIG. 1) is turned off, the peak voltage signal Vipk increases as the increase in the inductor current IL. Due to the output compensation current signal Iop being used to charge the peak voltage signal Vipk, the peak voltage signal Vipk needs less time to increase to the reference voltage REF and the duty cycle of the switch control signal CTRL decreases accordingly. As a result, the output voltage Vout recovers to the expected value rapidly.

In the example shown in FIG. 7, the output compensation circuit 120 includes a third transconductance amplifier A3, a fourth transconductance amplifier A4, a second current mirror CM2, a third current mirror CM3 and a fourth current mirror CM4.

The third transconductance amplifier A3 has a first input terminal, a second input terminal and an output terminal. The first input terminal receives the output voltage feedback signal Vfb, and the second input terminal receives the output voltage reference signal Vref. When the output voltage feedback signal Vfb is higher than the output voltage reference signal Vref, the third transconductance amplifier A3 provides a third current i3 at the output terminal.

The fourth transconductance amplifier A4 has a first input terminal, a second input terminal and an output terminal. The first input terminal receives the output voltage reference signal Vref, and the second input terminal receives the output voltage feedback signal Vfb. When the output voltage reference signal Vref is higher than the output voltage feedback signal Vfb, the fourth transconductance amplifier A4 provides a fourth current i4 at the output terminal.

The second current mirror CM2 has a first terminal, a second terminal and a ground terminal, where the first terminal is coupled to the output terminal of the third transconductance amplifier A3, and the ground terminal is coupled to the reference ground.

The third current mirror CM3 has a first terminal, a second terminal and a ground terminal, where the first terminal is coupled to the output terminal of the fourth transconductance amplifier A4, and the ground terminal is coupled to the reference ground.

The fourth current mirror CM4 includes a first terminal, a second terminal and a power supply terminal. The first terminal is coupled to the second terminal of the second current mirror CM2, the second terminal is coupled to the second terminal of the third current mirror CM3, and the power supply terminal is coupled to receive the supply voltage Vcc. The second terminal of the third current mirror CM3 and the second terminal the fourth current mirror CM4 are coupled together to provide the output compensation current signal Iop.

According to the embodiment shown in FIG. 7, when the output voltage Vout deviates from the expected value, the output compensation circuit 120 generates the variable output compensation current signal Iop to alter the peak voltage signal Vipk, causing the duty cycle of the switch control signal CTRL changes accordingly. This can enable the output voltage Vout to recover to the expected value rapidly.

Those skilled in the art can understand that the above embodiments are provided for illustrative purposes, not for limiting the scope of the present invention. Other circuits capable of achieving the same or similar functions also fall within the spirit and scope of the present invention. For example, the compensation current generator 112 may be implemented like the output compensation circuit 120 by using two transconductance amplifiers (the transconductance amplifiers A3 and A4 in FIG. 7) and multiple current mirrors (the current mirror CM1 in FIG. 6 and current mirrors CM2~CM4 in FIG. 7).

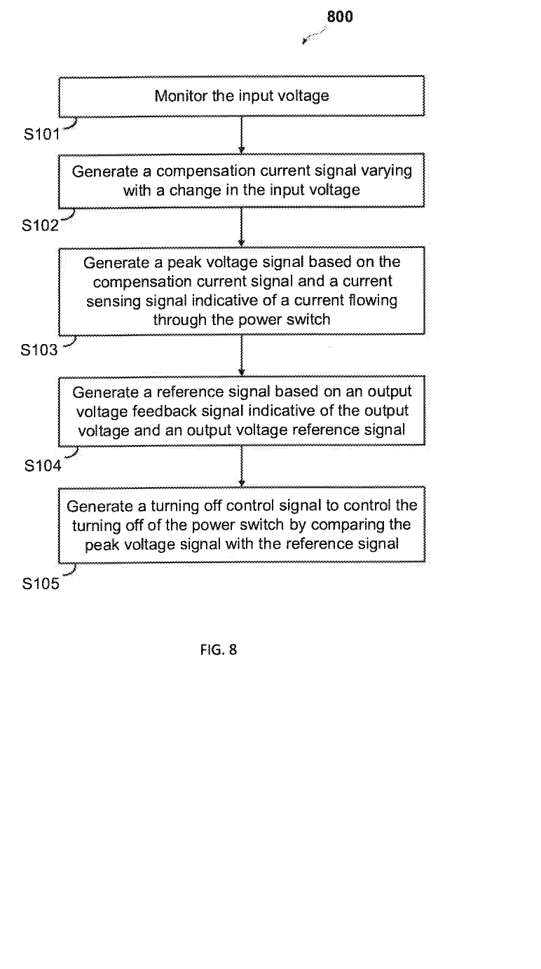

FIG. 8 illustrates a working flowchart of a control method 800 for a switching converter in accordance with an embodiment of the present invention. The switching converter includes a power switch and converts an input voltage to an output voltage based on the turning on and the turning off of the power switch. The control method 800 includes steps S101~S105.

At step S101, the input voltage is monitored.

At step S102, a compensation current signal varying with a change in the input voltage is generated.

At step S103, a peak voltage signal is generated based on the compensation current signal and a current sensing signal indicative of a current flowing through the power switch.

At step S104, a reference signal is generated based on an output voltage reference signal and an output voltage feedback signal indicative of the output voltage.

At step S105, a turning off control signal is generated to control the turning off of the power switch by comparing the peak voltage signal and the reference signal.

In one embodiment, the step S102 includes: a first voltage signal indicative of the input voltage is generated; a second voltage signal is generated by low-pass filtering the input voltage; and the compensation current signal is generated based on the first voltage signal and the second voltage signal.

In a further embodiment, the step S102 further includes: a first current signal is provided when the first voltage signal is lower than the second voltage signal; a second current signal is provided when the first voltage signal is higher than the second voltage signal; and the compensation current signal is generated based on the first current signal and the second current signal.

In one embodiment, the compensation current signal increases as the input voltage increases; the compensation current signal decreases as the input voltage decreases.

Those skilled in the art can understand that the high level/low level of control signal is related to the type of the power switch. For example, if the power switch is N-type MOSFET, when the control signal is high level, the power switch is turned on; when the control signal is low level, the power switch is turned off. If the power switch is P-type MOSFET, when the control signal is high level, the power switch is turned off; when the control signal is low level, the power switch is turned on. The high level/low level of the control signals shown in the above embodiments are used for illustrative purposes, not used for limiting the present invention.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order in accordance with such sequence unless it is specifically defined by the language of the claim. The process steps may be interchanged in any order without departing from the scope of the invention as long as such an interchange does not contradict the claim language and is not logically nonsensical.

Obviously, many modifications and variations of the present invention are possible in light of the above teachings. It is therefore to be understood that within the scope of the appended claims the invention may be practiced otherwise than as specifically described. It should be understood, of course, the foregoing disclosure relates only to a preferred embodiment (or embodiments) of the invention and that numerous modifications may be made therein without departing from the spirit and the scope of the invention as set forth in the appended claims. Various modifications are contemplated and they obviously will be resorted to by those skilled in the art without departing from the spirit and the scope of the invention as hereinafter defined by the appended claims as only a preferred embodiment(s) thereof has been disclosed.

What is claimed is:

1. A control circuit for a switching converter converting an input voltage to an output voltage, the control circuit comprising:
an input voltage detection circuit configured to generate a first voltage signal indicative of the input voltage and configured to generate a second voltage signal by low-pass filtering the input voltage;
a compensation current generator configured to generate a compensation current signal based on the first voltage signal and the second voltage signal; and
a comparison circuit configured to generate a turning off control signal to control the turning off of a power switch of the switching converter based on the compensation current signal, a current sensing signal indicative of a current flowing through the power switch and a reference signal.

2. The control circuit of claim 1, wherein:
when the input voltage increases, the compensation current signal increases; and wherein
when the input voltage decreases, the compensation current signal decreases.

3. The control circuit of claim 2, wherein after the input voltage stops changing and remains stable, the compensation current signal recovers to a steady-state value gradually.

4. The control circuit of claim 1, wherein the input voltage detection circuit comprises:
a voltage dividing circuit configured to generate the first voltage signal by dividing the input voltage; and
a low-pass filter configured to generate the second voltage signal by filtering the input voltage.

5. The control circuit of claim 1, wherein:
when the first voltage signal is lower than the second voltage signal, the compensation current generator is configured to provide a first current signal; and wherein
when the first voltage signal is higher than the second voltage signal, the compensation current is configured to provide a second current signal; and wherein
the compensation current generator is configured to provide the compensation current signal based on the first current signal and the second current signal.

6. The control circuit of claim 5, wherein the compensation current generator comprises:
a first transconductance amplifier having a first input terminal, a second input terminal and an output terminal, wherein the first input terminal is configured to receive the first voltage signal, and the second input terminal is configured to receive the second voltage signal;
a second transconductance amplifier having a first input terminal, a second input terminal and an output terminal, wherein the first input terminal is configured to receive the first voltage signal, the second input terminal is configured to receive the second voltage signal, and the output terminal is coupled to the output terminal of the first transconductance amplifier; and
a current mirror having a first terminal and a second terminal, wherein the first terminal is coupled to a common connection node of the output terminal of the first transconductance amplifier and the output terminal of the second transconductance amplifier, and the second terminal is configured to provide the compensation current signal.

7. The control circuit of claim 1, wherein the compensation current generator is further configured to receive a load current signal indicative of a load condition and configured to generate the compensation current signal based on the first voltage signal, the second voltage signal and the load current signal.

8. The control circuit of claim 7, wherein the compensation current generator comprises:
a first transconductance amplifier having a first input terminal, a second input terminal, a bias terminal and an output terminal, wherein the first input terminal is configured to receive the first voltage signal, the second input terminal is configured to receive the second voltage signal, and the bias terminal is coupled to a first current source controlled by the load current signal;
a second transconductance amplifier having a first input terminal, a second input terminal, a bias terminal and an output terminal, wherein the first input terminal is configured to receive the first voltage signal, the second input terminal is configured to receive the second voltage signal, the bias terminal is coupled to a second current source controlled by the load current signal, and the output terminal is coupled to the output terminal of the first transconductance amplifier; and
a current mirror having a first terminal and a second terminal, wherein the first terminal is coupled to a common connection node of the output terminal of the first transconductance amplifier and the output terminal of the second transconductance amplifier, and the second terminal is configured to provide the compensation current signal.

9. The control circuit of claim 1, further comprising:
an output feedback circuit configured to generate an output voltage feedback signal indicative of the output voltage;
an error amplifying circuit configured to generate the reference signal based on the output voltage feedback signal and an output voltage reference signal; and
a current voltage conversion circuit configured to convert a superimposed signal of the current sensing signal, the compensation current signal and a ramp current signal to a peak voltage signal; wherein
the comparison circuit is configured to generate the turning off control signal by comparing the peak voltage signal with the reference signal.

10. The control circuit of claim 9, further comprising:
an output compensation circuit configured to generate an output compensation current signal based on the output voltage feedback signal and the output voltage reference signal; wherein
the current voltage conversion circuit is configured to convert a superimposed signal of the output compensation current signal, the current sensing signal, the compensation current signal and the ramp current signal to the peak voltage signal.

11. A switching converter, comprising:
a switching circuit having a power switch and configured to convert an input voltage to an output voltage;
an input voltage detection circuit configured to generate a first voltage signal indicative of the input voltage and configured to generate a second voltage signal by low-pass filtering the input voltage;
a compensation current generator configured to generate a compensation current signal based on the first voltage signal and the second voltage signal; and
a comparison circuit configured to generate a turning off control signal to control the turning off of the power switch based on the compensation current signal, a current sensing signal indicative of a current flowing through the power switch and a reference signal.

12. The switching converter of claim 11, wherein:
when the input voltage increases, the compensation current signal increases; and wherein
when the input voltage decreases, the compensation current signal decreases.

13. The switching converter of claim 11, wherein:
when the first voltage signal is lower than the second voltage signal, the compensation current generator is configured to provide a first current signal; and wherein
when the first voltage signal is higher than the second voltage signal, the compensation current generator is configured to provide a second current signal; and wherein
the compensation current generator is configured to generate the compensation current signal based on the first current signal and the second current signal.

14. The switching converter of claim 13, wherein the compensation current generator comprises:
a first transconductance amplifier having a first input terminal, a second input terminal and an output terminal, wherein the first input terminal is configured to receive the first voltage signal, and the second input terminal is configured to receive the second voltage signal;
a second transconductance amplifier having a first input terminal, a second input terminal and an output terminal, wherein the first input terminal is configured to receive the first voltage signal, the second input terminal is configured to receive the second voltage signal, and the output terminal is coupled to the output terminal of the first transconductance amplifier; and
a current mirror having a first terminal and a second terminal, wherein the first terminal is coupled to a common connection node of the output terminal of the first transconductance amplifier and the output terminal of the second transconductance amplifier, and the second terminal is configured to provide the compensation current signal.

15. The switching converter of claim 11, wherein the compensation current generator is further configured to receive a load current signal indicative of a load condition and configured to generate the compensation current signal based on the first voltage signal, the second voltage signal and the load current signal.

16. The switching converter of claim 11, further comprising:
an output compensation circuit configured to generate an output compensation current signal based on an output voltage feedback signal indicative of the output voltage and an output voltage reference signal; wherein
the comparison circuit is configured to generate the turning off control signal based on the output compensation current signal, the compensation current signal, the current sensing signal and the reference signal.

17. The switching converter of claim 11, wherein the switching circuit comprises a boost converter, a buck converter or a buck-boost converter.

18. A control method for a switching converter converting an input voltage to an output voltage, the control method comprising:
monitoring the input voltage;
generating a compensation current signal varying with a change in the input voltage; and
generating a turning off control signal to control the turning off of a power switch of the switching converter based on the compensation current signal, a current sensing signal indicative of a current flowing through the power switch and a reference signal.

19. The control method of claim 18, wherein:
when the input voltage increases, the compensation current signal increases; and
when the input voltage decreases, the compensation current signal decreases.

20. The control method of claim 18, wherein the step of generating the compensation current signal comprises:
generating a first voltage signal indicative of the input voltage;
generating a second voltage signal by low-pass filtering the input voltage; and
generating the compensation current signal based on the first voltage signal and the second voltage signal.
